(19) United States
(12) Patent Application Publication
(10) Pub. No.: US 2018/0374063 A1
(43) Pub. Date: Dec. 27, 2018

(54) SYSTEM AND METHOD FOR DISTRIBUTING DATA CONCERNING A TRANSACTION OVER A NETWORK

(71) Applicant: TOSHIBA TEC KABUSHIKI KAISHA, Tokyo (JP)

(72) Inventors: Tsuyoshi GOTANDA, Oota Tokyo (JP); Akiko SUSAKI, Oota Tokyo (JP)

(21) Appl. No.: 15/636,943

(22) Filed: Jun. 29, 2017

Related U.S. Application Data
(63) Continuation of application No. 14/321,066, filed on Jul. 1, 2014, now abandoned.

(30) Foreign Application Priority Data
Jul. 3, 2013 (JP) 2013-139941

(51) Int. Cl. G06Q 20/04; G06Q 20/20; G06F 17/30; G06Q 30/06; G06Q 20/32

(52) U.S. Cl. CPC G06Q 20/0453; G06Q 20/202; G06Q 20/0457; G06Q 20/322; G06Q 20/20; G06Q 30/06; G06F 17/30864

(57) ABSTRACT

An information processing apparatus includes a member correlating unit that correlates a membership code to a user, an electronic receipt receiving unit that receives electronic receipt information correlated with the membership code from an electronic receipt managing server that manages the electronic receipt information, and an electronic receipt displaying unit that displays a plurality of selectable process categories corresponding to the electronic receipt information received from the electronic receipt receiving unit in a menu on a display unit.

### BACKGROUND

In receipt issuing systems of the related art, a receipt may be handed to a purchaser at a store at the time of payment or an electronic receipt may be electronically issued to the portable terminal or the like of the purchaser.

In this latter case, it is possible to decrease the consumption of the receipt paper by converting the receipt into electronic data. Accordingly, it is helpful to a store that introduces an electronic receipt system. In addition, it is known to perform merchandise sales promotion or promotional advertising by electronically adding a coupon or the like relating to the purchased merchandise to the electronic receipt.

However, in the related art, if the electronic receipt is not viewed, various additional information (a proof of purchase, a store issued coupon, and the like) may not be confirmed.

### DESCRIPTION OF THE DRAWINGS

FIG. 1 is a configuration diagram illustrating an overall configuration of an electronic receipt system according to an embodiment.

FIG. 2 is a menu screen that selects a process corresponding to electronic receipt information in a portable terminal.

FIG. 3 is a block diagram illustrating a configuration of a main portion of the portable terminal.

FIG. 4 is a block diagram illustrating a configuration of a main portion of a POS terminal.

FIG. 5 is a block diagram illustrating a configuration of a main portion of an electronic receipt server.

FIG. 6 is a block diagram illustrating a configuration of a main portion of an electronic receipt managing server.

FIG. 7 is a functional block diagram illustrating an electronic receipt process in the POS terminal.

FIG. 8 is a flow chart illustrating a flow of the electronic receipt process.

FIG. 9 is a flow chart illustrating a flow of an information transmission process in the electronic receipt server.

FIG. 10 is a functional block diagram corresponding to an electronic receipt managing process and a merchandise information transmission process in the electronic receipt managing server.

FIG. 11 is a flow chart illustrating a flow of the electronic receipt managing process and the merchandise information transmission process.

FIG. 12 is a functional block diagram corresponding to an electronic receipt accepting process and an electronic receipt viewing process in the portable terminal.

FIGS. 13A to 13C are flow charts illustrating a flow of the electronic receipt accepting process and the electronic receipt viewing process.

FIG. 14 is a front view illustrating a display example in a portable terminal.

FIG. 15 is a front view illustrating a display example in the portable terminal.

FIG. 16 is a front view illustrating a display example in the portable terminal.

FIG. 17 is a front view illustrating a display example in the portable terminal.

FIG. 18 is a front view illustrating a display example in the portable terminal.

FIG. 19 is a front view illustrating a display example in the portable terminal.

FIG. 20 is a front view illustrating a display example in the portable terminal.

FIG. 21 is a front view illustrating a display example in the portable terminal.

FIG. 22 is a front view illustrating a display example in the portable terminal.

FIG. 23 is a front view illustrating a display example in the portable terminal.

### DETAILED DESCRIPTION

Embodiments provide an information processing apparatus and a program that may effectively and intuitively perform an operation of a purchaser for confirming a plurality of process categories corresponding to electronic receipt information.

In general, according to one embodiment, there is provided an information processing apparatus including a member correlating unit that correlates a membership code to a user, an electronic receipt receiving unit that receives electronic receipt information correlated with the membership code from an electronic receipt managing server that manages the electronic receipt information, and an electronic receipt displaying unit that displays a plurality of selectable process categories corresponding to the electronic receipt information received from the electronic receipt receiving unit in a menu on a display unit.

An exemplary embodiment is described with reference to the drawings.

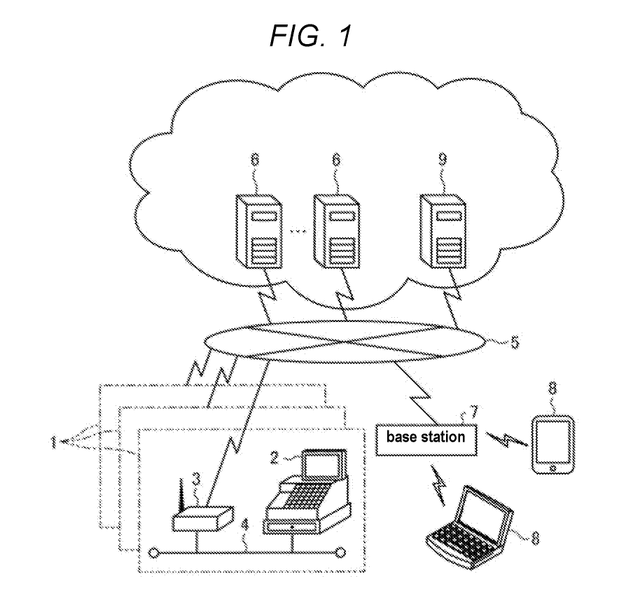

FIG. 1 is a configuration diagram illustrating an overall configuration of an electronic receipt system according to an exemplary embodiment. As illustrated in FIG. 1, a store 1 is provided with a Point of Sales (POS) terminal 2 (FIG. 1 illustrates one terminal, but a plurality of terminals may be provided) that is a merchandise sales data processing apparatus executing a merchandise sales data process, and a router 3. The POS terminal 2 and the router 3 are connected through an in-store Local Area Network 4 (LAN). The router 3 is a device for connecting the in-store LAN 4 with another network 5, e.g., the Internet or a Virtual Private Network (VPN). Further, though it is not illustrated, the store 1 may be provided with a store server that manages the POS terminal 2.

An electronic receipt server 6 is connected to a network 5. The plurality of electronic receipt servers 6 are provided on a per company basis, and the companies may be a seller of merchandise or a service who operates a store or a chain of stores, such as a convenience store, a supermarket, a grocery store, a drug store, an apparel store, a home electric appliance store, a department store, a household goods store, and a restaurant (hereinafter referred to as a “store”), and function as company receipt managing servers which store and manage electronic receipt information according to company code indicating the company that operates the stores. In addition, a headquarter server of a POS system, having functions such as sales management, sales analysis, or inventory management for each company that operates the stores may be used with the electronic receipt server 6.

In addition, a portable terminal 8 is connected to the network 5 through a base station 7 that performs wireless communication according to a standard such as Wireless Fidelity (Wi-Fi). The portable terminal 8 is an information processing apparatus in which a Web browser is installed, and may be a smart phone, a mobile phone, a Personal Digital Assistant (PDA), a tablet computer, and the like. Further, an information processing apparatus such as a personal computer including a notebook PC or the like may be used in place of the portable terminal 8.

Further, an electronic receipt managing server 9 functioning as a customer receipt managing server that stores electronic receipt information of various companies that operate the stores and manages the electronic receipt information is also connected to the network 5. The consumer (i.e., purchaser of merchandise or store customer) who went through membership registration in advance in order to receive an electronic receipt service may obtain electronic receipt information from the electronic receipt managing server 9 by using the portable terminal 8 through the network 5. The electronic receipt managing server 9 is managed by a third party organization other than the company who manages the electronic receipt information, for example, by the electronic receipt server 6. Further, a third party organization or the like may manage the electronic receipt server 6. In addition, a function of the electronic receipt server 6 may be included in the electronic receipt managing server 9 so as to be managed by one server. In addition, a service (application) may provide a function of collectively managing electronic receipt information according to company code which indicates the company that operates the stores in a form of, for example, Software as a Service (SaaS) which is a kind of cloud computing.

Further, membership registration of a consumer for receiving an electronic receipt service is performed, for example, as follows. The consumer transmits a blank email to a member managing server (not illustrated) from the portable terminal 8 through the network 5. The member managing server transmits a Uniform Resource Locator (URL) indicating a page for membership registration to the received email address. The consumer accesses the URL indicating a page for the membership registration from the portable terminal 8, causes an input screen H to be displayed, and inputs items required for the membership registration. An input confirmation screen is displayed in the portable terminal 8 after the input of the required items by the consumer has ended. Then, the membership registration is performed by the member management server after the input confirmation by the consumer. Thereafter, the member managing server delivers a membership registration completion email including a membership code and a password to the portable terminal 8. According to this, the membership registration is completed.

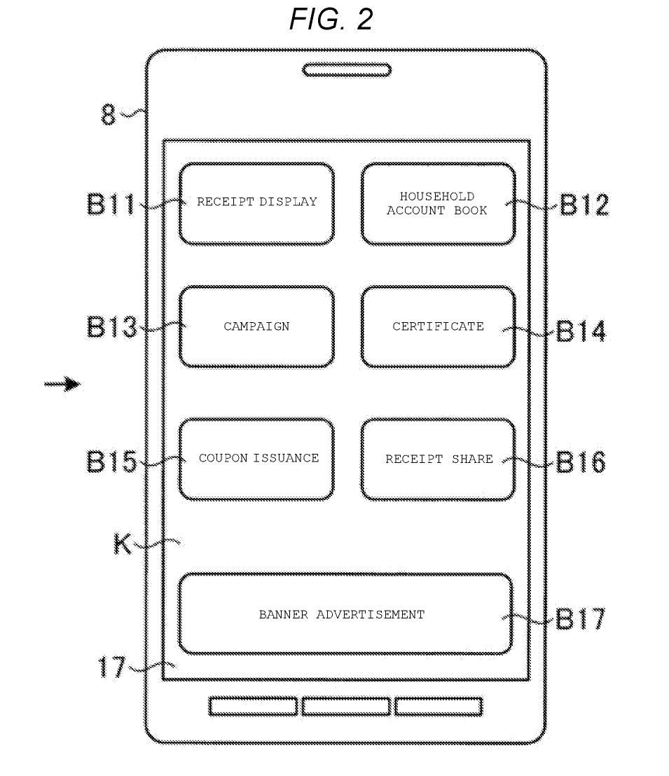

A top screen K illustrated in FIG. 2 is a menu screen for causing a consumer to select a plurality of process categories corresponding to the electronic receipt information through an input unit 18 which is a selecting unit. The top screen K has a receipt display button B11, a household account book button B12, a campaign registration button B13, a certificate button B14, a coupon issuing button B15, a receipt sharing button B16, and a banner advertisement button B17.

The receipt display button B11 is a button for viewing the electronic receipt information. The household account book button B12 is a button for viewing a summary of the electronic receipt information. The campaign button B13 is a button for applying for a campaign (reward).

The certificate button B14 is a button for viewing the electronic receipt information to which a certificate has been added. The coupon issuing button B15 is a button for viewing a list of the electronic receipt information to which coupons issued by the stores have been added. The receipt sharing button B16 is a button for sharing the electronic receipt information by transferring a portion or all of the electronic receipt information to a friend or a family member.

In addition, the banner advertisement button B17 is a button for viewing an associated commercial.

In the electronic receipt system of the configuration, the electronic receipt information indicating the payment content generated by the merchandise sales data processing by the POS terminal 2 of the store 1 is transmitted to the electronic receipt managing server 9 through the network 5 and the electronic receipt server 6, and the electronic receipt information is transmitted from the electronic receipt managing server 9 to the portable terminal 8 of the member. The member may cause the electronic receipt information to be displayed on the display unit of the portable terminal 8, and confirm the content of the electronic receipt information. In addition, the electronic receipt managing server 9 publishes the electronic receipt information on the Web. The portable terminal 8 in which the Web browser is mounted may designate the Uniform Resource Locator (URL), download the electronic receipt information published on the Web to the portable terminal 8 to be viewed on the Web browser. Further, the electronic receipt information may be viewed by installing application software for viewing the electronic receipt information on the portable terminal 8.

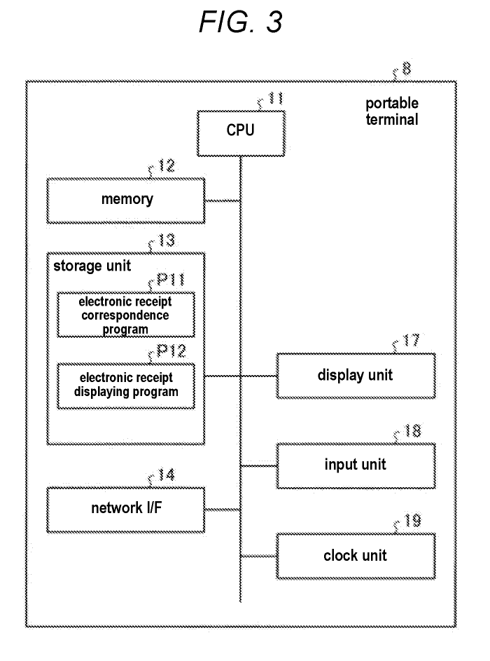

The portable terminal 8 stores the membership code and the password obtained by the consumer in such a manner as described above in a storage unit 13 (see FIG. 3) or the like. An output method of the membership code stored in this manner may be barcode display, two-dimensional code display, transmission by information communication by Near Field Communication (NFC), which is near field-type wireless communication, or the like.

Hereinafter, together with the above, a configuration of each unit that configures the electronic receipt system according to the exemplary embodiment is described.

First, a configuration of the main portion of the portable terminal 8 which is the information processing apparatus is described with reference to the block diagram of FIG. 3. As illustrated in FIG. 3, the portable terminal 8 is configured with a Central Processing Unit (CPU) 11, a memory 12 that temporarily stores data, the storage unit 13 that may read and write an instruction from the CPU 11 and store a program, data, or the like, a network interface 14 which is connected to various public networks including the network 5, a display unit 17 that may display various information, an input unit 18 for operating the portable terminal 8, a clock unit 19 that tracks time, and the like. The input unit 18 is a touch panel stacked on the display unit 17, or keys provided on the housing, and also functions as a selecting unit.

In addition to the Web browser by which various information (contents) published on the Web is viewed, an electronic receipt correspondence program P11 that receives the electronic receipt information generated after the payment according to the merchandise sales data process from the electronic receipt managing server 9 and an electronic receipt displaying program P12 for displaying the received electronic receipt information for viewing, are installed in advance on the storage unit 13.

Further, the electronic receipt correspondence program P11 and the electronic receipt displaying program P12 executed in the portable terminal 8 are stored on a non-transitory computer readable medium such as a CD-ROM, a flexible disk (FD), a CD-R, and a Digital Versatile Disk (DVD), as a file of an installable format or an executable format to be provided.

In addition, the electronic receipt correspondence program P11 and the electronic receipt displaying program P12 executed by the portable terminal 8 may be configured in a computer connected to the network such as the Internet and downloaded through the network. In addition, the electronic receipt correspondence program P11 and the electronic receipt displaying program P12 executed by the portable terminal 8 may be configured so as to be provided or distributed through the network such as the Internet.

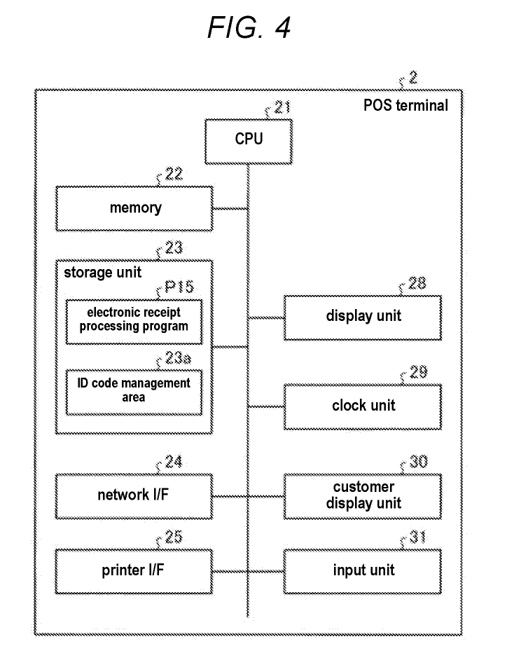

Next, a configuration of the main portion of the POS terminal 2 which is the merchandise sales data processing apparatus is described with reference to the block diagram of FIG. 4. As illustrated in FIG. 4, the POS terminal 2 is configured with a Central Processing Unit (CPU) 21, a memory 22 that temporarily stores data, a storage unit 23 that may read and write an instruction from the CPU 21 and store a program, data, or the like, a network interface 24 which is connected to the in-store LAN 4, a printer interface 25 to which a printer is connected, an operator display unit 28 for displaying various information to an operator, a clock unit 29 that tracks time, a customer display unit 30 that displays various information to a customer, an input unit 31 that operates the POS terminal 2, and the like.

An identification code management area 23a is reserved in the storage unit 23 as an area for storing in advance a company code (an identification code of a company that operates the store), a business type and business category code, a store code indicating the store 1 in which the corresponding POS terminal 2 is installed, or the like in addition to a POS number of the corresponding POS terminal 2. Here, the business type and business category code described above is a code (classification code) that distinguishes the business type or business category of the store, for example, as a convenience store, a supermarket, a department store, a pharmacy, or a restaurant. Further, such business type or business category may be arbitrarily changed as desired by the user. Further, a company code (an identification code of a company that operates a store), and a business type and business category code may be registered in the electronic receipt server 6.

In addition, an electronic receipt processing program P15 for processing a receipt printed and issued in the merchandise sales data processing or electronic receipt information electronically processed in place of a paper receipt is installed in advance on the storage unit 23, in addition to software for executing various POS operations including the merchandise sales data processing.

Further, the electronic receipt processing program P15 executed in the POS terminal 2 is stored on a non-transitory computer readable medium such as a CD-ROM, a flexible disk (FD), a CD-R, and a Digital Versatile Disk (DVD) as a file of an installable format or an executable format to be provided.

In addition, the electronic receipt processing program P15 executed in the POS terminal 2 may be configured in a computer connected to the network such as the Internet and downloaded through the network. In addition, the electronic receipt processing program P15 executed by the POS terminal 2 maybe configured so as to be provided or distributed through the network such as the Internet.

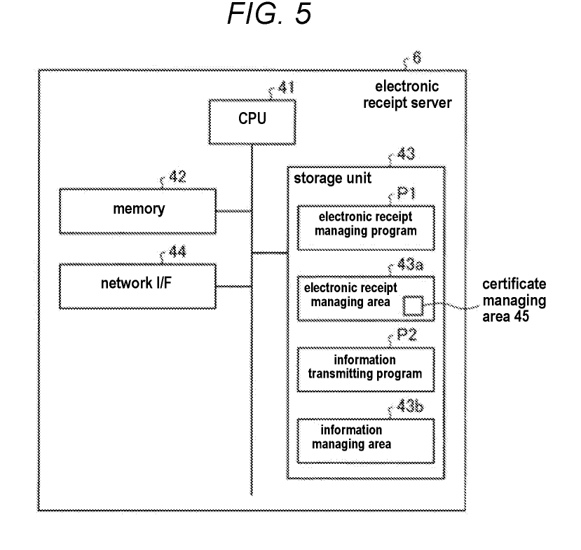

Next, a configuration of the main portion of the electronic receipt server 6 functioning as the company receipt managing server is described with reference to the block diagram of FIG. 5. The electronic receipt server 6 is configured with a Central Processing Unit (CPU) 41, a memory 42 that temporarily stores data, a storage unit 43 that may read and write an instruction from the CPU 41 and store a program, data, or the like, a network interface 44 which is connected to the network 5, and the like.

An electronic receipt managing area 43a is reserved in the storage unit 43 as an area for storing the electronic receipt information by company that operates the store. The electronic receipt information includes a company code (an identification code of a company that operates a store), a business type and business category code, a store code, a consumer membership code, a POS number of the POS terminal 2, a receipt number, merchandise sales data, and the like.

In addition, a certificate managing area 45 that stores the certificate information of merchandise that requires a certificate is reserved in the electronic receipt managing area 43a. The merchandise information of merchandise for which a certificate has been issued, certificate period information, certificate regulation information, manufacturer contact information, and the like are stored on a per merchandise item basis in the certificate managing area 45.

In addition, an electronic receipt managing program P1 for managing the electronic receipt information received from the POS terminal 2 of each store 1 in the electronic receipt managing area 43a is installed in advance in the storage unit 43.

In addition, an information transmitting program P2 for transmitting the electronic receipt information managed in the electronic receipt managing area 43a to the electronic receipt managing server 9 is installed in advance in the storage unit 43.

Further, an information managing area 43b that stores various additional information associated with the desired merchandise, member, company, and store is provided in the storage unit 43. Here, the additional information is access information such as a URL liked to a home page associated with a campaign of a company, a URL linked to a home page associated with a commercial of a company, and a URL linked to a coupon of a company.

Further, the electronic receipt managing program P1 and the information transmitting program P2 executed in the electronic receipt server 6 are stored on a non-transitory computer readable medium such as a CD-ROM, a flexible disk (FD), a CD-R, a Digital Versatile Disk (DVD) as a file of an installable format or an executable format to be provided.

In addition, the electronic receipt managing program P1 and the information transmitting program P2 executed in the electronic receipt server 6 may be configured in a computer connected to the network such as the Internet and downloaded through the network. In addition, the electronic receipt managing program P1 and the information transmitting program P2 executed by the electronic receipt server 6 maybe configured so as to be provided or distributed through the network such as the Internet.

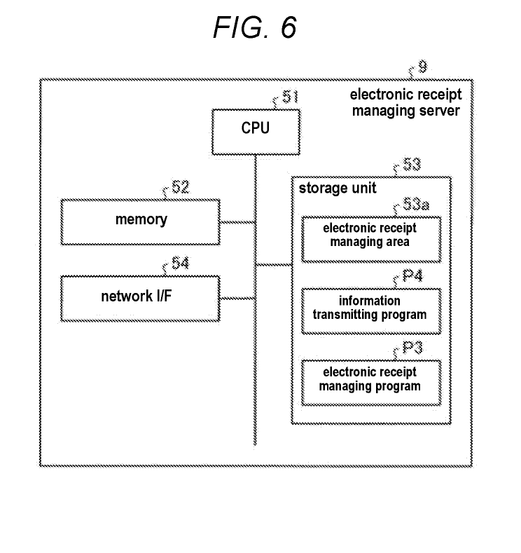

Next, a configuration of the main portion of the electronic receipt managing server 9 functioning as the customer receipt managing server is described by using the block diagram of FIG. 6. The electronic receipt managing server 9 is configured with a Central Processing Unit (CPU) 51, a memory 52 that temporarily stores data, a storage unit 53 that may read and write an instruction from the CPU 51 and store a program, data, or the like, a network interface 54 which is connected to the network 5, and the like.

An electronic receipt managing area 53a is reserved in the storage unit 53 as an area for storing various company electronic receipt information to operate the store. More specifically, the electronic receipt managing area 53a manages various company electronic receipt information and additional information. The electronic receipt information includes a membership code, a company code (an identification code of a company that operates a store), a store code, a POS number of the POS terminal 2, a receipt number, merchandise sales data, additional information, and the like.

In addition, an electronic receipt managing program P3 for managing additional information and electronic receipt information received from the electronic receipt server 6 of each company in the electronic receipt managing area 53a is installed in advance in the storage unit 53.

In addition, an information transmitting program P4 for transmitting the electronic receipt information and the additional information of the desired merchandise to the portable terminal 8 is installed in advance in the storage unit 53.

Further, the electronic receipt managing program P3 and the information transmitting program P4 executed by the electronic receipt managing server 9 are stored on a non-transitory computer readable medium such as a CD-ROM, a flexible disk (FD), a CD-R, a Digital Versatile Disk (DVD) as a file of an installable format or an executable format to be provided.

In addition, the electronic receipt managing program P3 and the information transmitting program P4 executed by the electronic receipt managing server 9 may be configured in a computer connected to the network such as the Internet and downloaded through the network. In addition, the electronic receipt managing program P3 and the information transmitting program P4 executed by the electronic receipt managing server 9 maybe configured so as to be provided or distributed through the network such as the Internet.

Subsequently, an operation of each unit that configures the system according to the exemplary embodiment is described.

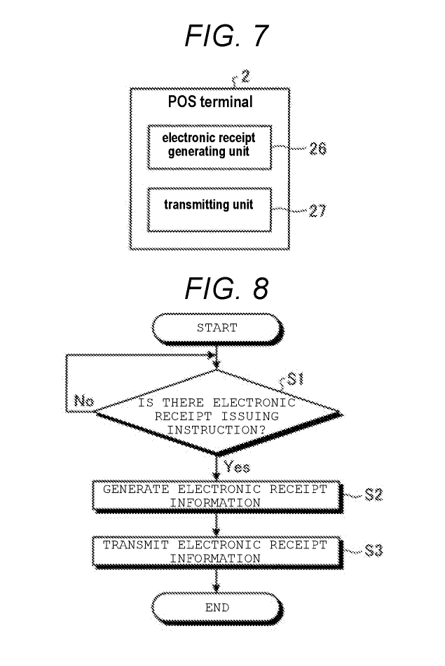

First, an electronic receipt process executed by the CPU 21 of the POS terminal 2 operating according to the electronic receipt processing program P15 is described with reference to the functional block diagram illustrated in FIG. 7 and a flow chart illustrated in FIG. 8.

As illustrated in FIG. 7, the electronic receipt processing program P15 executed in the POS terminal 2 is modularly configured to include an electronic receipt generating unit 26 functioning as an electronic receipt generating section, and a transmitting unit 27 functioning as a transmitting section. The CPU 21 reads and executes the electronic receipt processing program P15 from the storage unit 23 so that each of the units is loaded into the memory 22. The electronic receipt generating unit 26 and the transmitting unit 27 are operating within the memory 22.

The electronic receipt generating unit 26 includes a company code indicating the company that operates the store, and generates a receipt printed and issued during the merchandise sales data processing or electronic receipt information electronically processed in place of the receipt in association with a consumer membership code.

The transmitting unit 27 transmits the electronic receipt information generated by the electronic receipt generating unit 26 to the electronic receipt server 6 managed for each company according to the company code.

As illustrated in FIG. 8, if there is an input of settlement processing key for starting a merchandise transaction settlement process, the CPU 21 (the electronic receipt generating unit 26) of the POS terminal 2 determines whether there is an electronic receipt issuing instruction corresponding to an input of a membership code, confirmation on whether an electronic receipt is issued or not, and a payment process according to a settlement operation (Step S1).

For example, a method as described below may be implemented for a member to make an electronic receipt issuing instruction.

1. A salesperson operates an “electronic receipt issuance” button provided in the input unit 31 (for example, a keyboard) of the POS terminal 2.

2. If a consumer who is a member causes a barcode including a trigger code to be displayed on the display unit 17 of the portable terminal 8, the salesperson causes the input unit 31 (for example, a barcode scanner) of the POS terminal 2 to read the barcode.

3. The consumer who is the member operates an “electronic receipt issuance” button displayed on the customer display unit 30.

4. The consumer who is the member causes the barcode including the trigger code to be displayed on the display unit 17 of the portable terminal 8, and the consumer who is the member himself or herself causes the input unit 31 (for example, a barcode scanner (preferably a separate scanner from the scanner used for the merchandise registration)) of the POS terminal 2 to read the barcode.

5. The consumer who is the member presents a company membership card to receive loyalty points, the company membership code of the company membership card is read by the input unit 31 (for example, a barcode scanner, a magnetic card reader, or NFC) of the POS terminal 2, and it is determined that there is an electronic receipt issuing instruction if a membership code of the electronic receipt is related to the read company membership code.

When it is determined that there is an electronic receipt issuing instruction (Yes in Step S1), the CPU 21 (the electronic receipt generating unit 26) of the POS terminal 2 transmits merchandise transaction data to the headquarter server, extracts a company code (an identification code of the company that operates the store), a business type and business category code, a store code, a consumer membership code, a POS number of the POS terminal 2, a receipt number, merchandise sales data, or the like, in addition to the merchandise transaction data, based on the merchandise information and payment information registered at the time of payment according to the merchandise sales data processing, from the merchandise sales data managing area provided in the memory 22, and generates the electronic receipt information (Step S2).

Next, the CPU 21 (the transmitting unit 27) of the POS terminal 2 which is connected to the in-store LAN 4 and the network 5 through the network interface 24, transmits the generated electronic receipt information to the electronic receipt server 6 (Step S3), and ends the process. Further, when it is determined that there is no electronic receipt issuing instruction, the CPU 21 prints and issues a paper receipt, transmits the merchandise sales data to the headquarter server, and ends the process.

Next, the flow of the information transmission process executed by the operation of the CPU 41 of the electronic receipt server 6 according to the information transmitting program P2 and the electronic receipt managing process executed by the operation according to the electronic receipt managing program P1 are described with reference to the flow chart illustrated in FIG. 9.

If the CPU 41 of the electronic receipt server 6 receives the electronic receipt information transmitted from the POS terminal 2 through the network interface 44 (Yes in Step S11), the electronic receipt information is stored as electronic receipt information of the company in the electronic receipt managing area 43a of the storage unit 43 (Step S12). That is, the CPU 41 of the electronic receipt server 6 functions as electronic receipt managing section for managing the electronic receipt information on a per company basis according to the company code in the storage unit 43.

At this point, the CPU 41 searches the certificate managing area 45 with respect to the electronic receipt information transmitted from the POS terminal 2. Then, as a result of the search, the CPU 41 determines whether there is merchandise having the certificate information in the certificate managing area 45 with respect to the information of the electronic receipt information transmitted from the POS terminal 2. When it is determined that there is merchandise having the certificate information, the CPU 41 stores the electronic receipt information by attaching the status indicating that there is the certificate information in association with the electronic receipt information of the merchandise (Step S12).

In addition, after the received electronic receipt information is stored, if the preset transmission timing is reached (No in Step S11, Yes in Step S13), the CPU 41 of the electronic receipt server 6 transmits the additional information managed in the information managing area 43b and the electronic receipt information managed in the electronic receipt managing area 43a to the electronic receipt managing server 9 (Step S14), and the process returns to Step S11.

In addition, when the status indicating that there is the certificate information in association with the transmitted electronic receipt information is attached, the CPU 41 transmits the electronic receipt information in association with status to the electronic receipt managing server 9 (Step S14), and the process returns to Step S11.

In addition, if it is determined that the transmission timing is not reached (No in Step S13), the CPU 41 of the electronic receipt server 6 determines whether a certificate check request is received from the electronic receipt managing server 9 described below (Step S15). If it is determined that the certificate check request is received (Yes in Step S15), the CPU 41 reads the certificate information of the corresponding merchandise from the certificate managing area 45 and transmits the certificate information to the electronic receipt managing server 9 (Step S16). If it is determined that the certificate check request is not received (No in Step S15), the process of the CPU 41 returns to Step S11.

Further, though the CPU 21 (the electronic receipt generating unit 26) of the POS terminal 2 generates the electronic receipt information and transmits the electronic receipt information to the electronic receipt server 6, but the process is not limited thereto. For example, the CPU 21 of the POS terminal 2 transmits a store code, a consumer membership code, a POS number of the POS terminal 2, a receipt number, a merchandise sales data, and the like to the electronic receipt server 6 based on the merchandise information and the payment information registered at the time of payment according to the merchandise sales data processing, and the CPU 41 of the electronic receipt server 6 may generate the electronic receipt information by adding the company code, the business type and business category code, or the like.

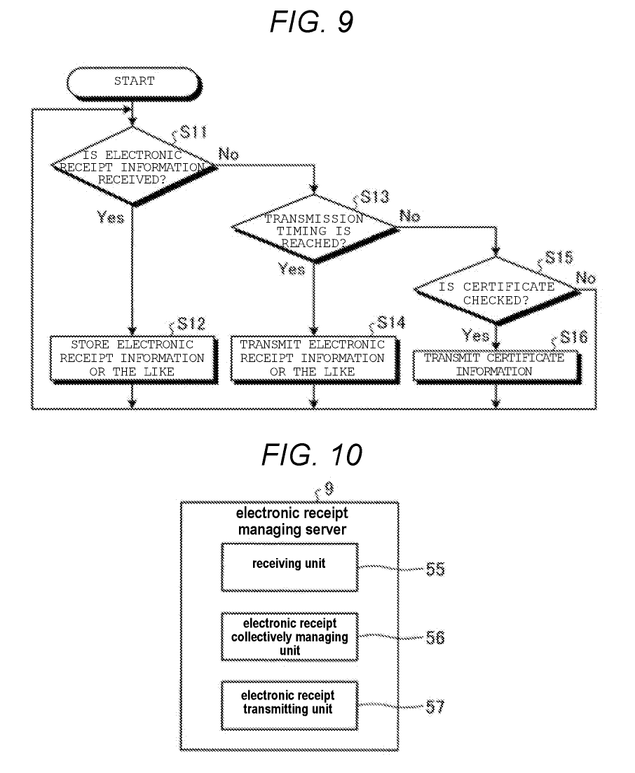

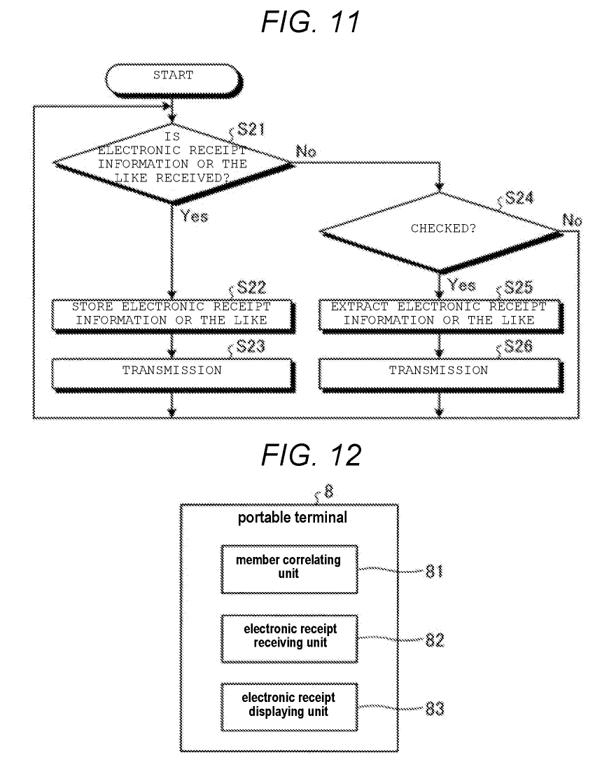

Next, the flow of the electronic receipt managing process executed by the operation of the CPU 51 of the electronic receipt managing server 9 according to the electronic receipt managing program P3 and the merchandise information transmission process executed by the operation of the CPU 51 of the electronic receipt managing server 9 according to the information transmitting program P4 are described with reference to the functional block diagram illustrated in FIG. 10 and the flow chart illustrated in FIG. 11.

As illustrated in FIG. 10, the electronic receipt managing program P3 and the information transmitting program P4 executed by the electronic receipt managing server 9 each are modularly configured to include a receiving unit 55 functioning as receiving section, an electronic receipt managing unit 56 functioning as electronic receipt managing section, and an electronic receipt transmitting unit 57 functioning as electronic receipt transmitting section. The CPU 51 reads and executes the electronic receipt managing program P3 and the information transmitting program P4 from the storage unit 53 so that each of the units is loaded into the memory 52, and the receiving unit 55, the electronic receipt managing unit 56, and the electronic receipt transmitting unit 57 are operating within the memory 52.

The receiving unit 55 includes a company code indicating the company that operates the store, and receives the receipt printed and issued in the merchandise sales data processing or electronic receipt information based on a company which is electronically processed in place of the receipt.

The electronic receipt managing unit 56 performs management by storing the electronic receipt information which is received from the receiving unit 55 on a per company basis in the electronic receipt managing area 53a of the storage unit 53.

The electronic receipt transmitting unit 57 obtains the electronic receipt information including one or more company codes associated with the membership code to the portable terminal 8 corresponding to the predetermined consumer membership code, from the electronic receipt managing area 53a to transmit the electronic receipt information.

As illustrated in FIG. 11, the CPU 51 (the receiving unit 55) of the electronic receipt managing server 9 determines whether the electronic receipt information and the additional information transmitted from the electronic receipt server 6 of each company are received through the network interface 54 (Step S21).

If the electronic receipt information and the additional information are received (Yes in Step S21), the CPU 51 (the electronic receipt managing unit 56) of the electronic receipt managing server 9 stores the electronic receipt information and the additional information in the electronic receipt managing area 53a of the storage unit 53 (Step S22). The CPU stores the status and the certificate information if transmitted, and manages the status and the certificate information together with the electronic receipt information (Step S22).

In addition, after storing the electronic receipt information and the additional information in the electronic receipt managing area 53a, the CPU 51 (the electronic receipt transmitting unit 57) of the electronic receipt managing server 9 transmits the electronic receipt information and the additional information to the portable terminal 8 (Step S23), and the process returns to Step S21. Further, if the transmission of the electronic receipt information is completed, the transmission result of the electronic receipt information may be managed by storing a flag indicating the transmission completion of the electronic receipt information in the electronic receipt managing area 53a.

If a status is received from the electronic receipt server 6, the CPU 51 generates information (for example, information of a character of “certificate”) indicating that the certificate exists, together with the electronic receipt information and transmits the information to the portable terminal 8 (Step S23).

In addition, if the electronic receipt information is checked from the portable terminal 8 (No in Step S21, Yes in Step S24), the CPU 51 (the electronic receipt transmitting unit 57) of the electronic receipt managing server 9 extracts the additional information and the electronic receipt information managed in the electronic receipt managing area 53a (Step S25), and then transmits the additional information and the electronic receipt information to the portable terminal 8 at which the check is performed (Step S26), and the process returns to Step S21.

If the certificate information is checked from the portable terminal 8, the certificate information stored in Step S22 is transmitted to the portable terminal 8 at which the check is performed together with the electronic receipt information (Step S26).

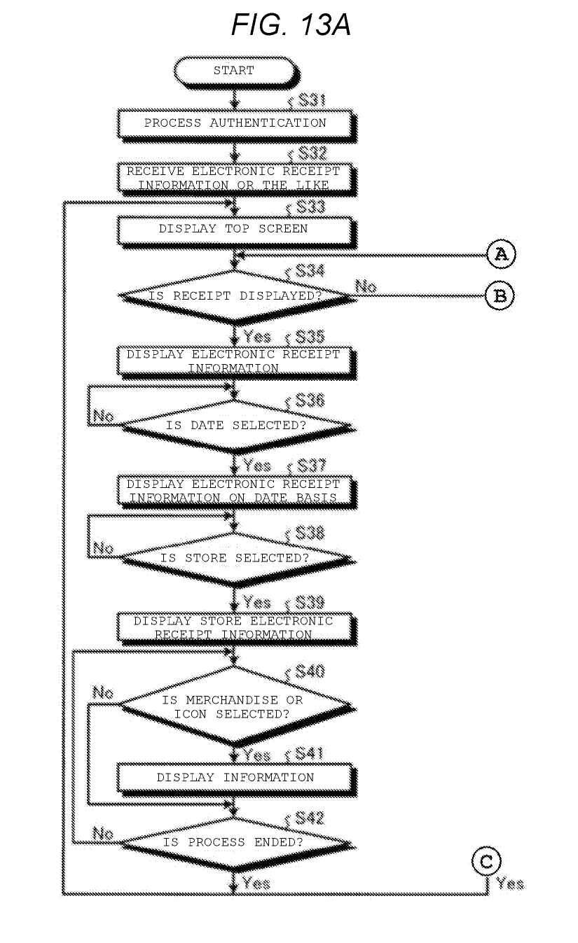

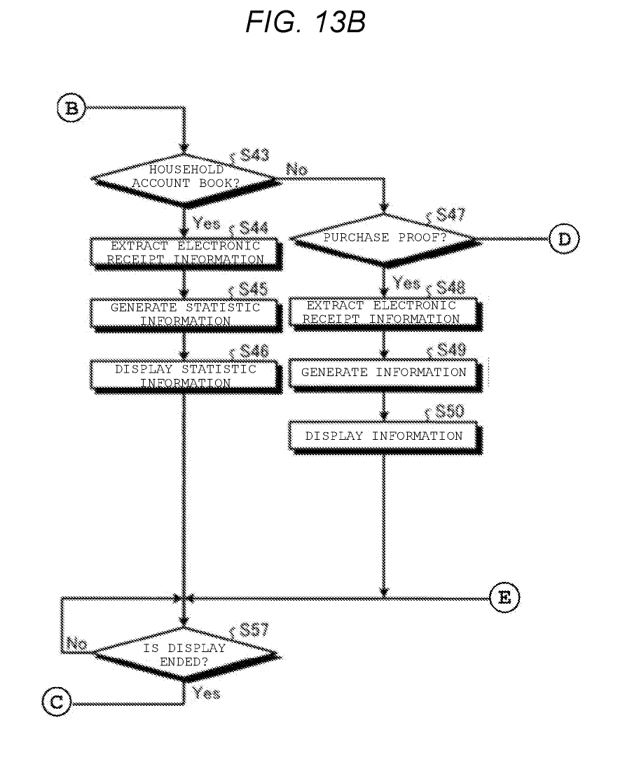

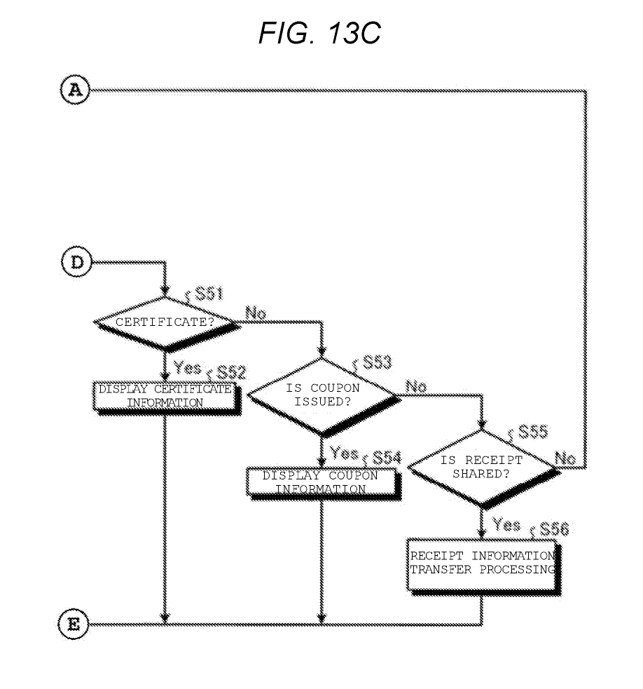

Next, the flow of the electronic receipt receiving process executed by the operation of the CPU 11 of the portable terminal 8 according to the electronic receipt correspondence program P11 and the electronic receipt viewing process executed by the operation of the CPU 11 of the portable terminal 8 according to the electronic receipt viewing program P12 are described with reference to the functional block diagram illustrated in FIG. 12 and the flowcharts illustrated in FIGS. 13A to 13C.

As illustrated in FIG. 12, the electronic receipt correspondence program P11 and the electronic receipt viewing program P12 executed by the portable terminal 8 each are modularly configured to include a member correlating unit 81 functioning as member correlating section, an electronic receipt receiving unit 82 functioning as electronic receipt receiving section, and an electronic receipt displaying unit 83 functioning as electronic receipt displaying section. The CPU 11 reads and executes the electronic receipt correspondence program P11 and the electronic receipt viewing program P12 from the storage unit 13 so that each of the units is loaded into the memory 12, and the member correlating unit 81, the electronic receipt receiving unit 82, and the electronic receipt displaying unit 83 are operated within the memory 12.

The member correlating unit 81 correlates a predetermined consumer membership code.

The electronic receipt receiving unit 82 receives the electronic receipt information including one or more company codes associated with the membership code from the electronic receipt managing server 9 that manages the corresponding electronic receipt information.

The electronic receipt displaying unit 83 aligns the electronic receipt information received from the electronic receipt receiving unit 82 according to the company code and displays the electronic receipt information on the display unit 17.

In addition, the electronic receipt displaying unit 83 displays a plurality of process categories corresponding to the electronic receipt information received from the electronic receipt receiving unit 82 as a selectable menu (the top screen K illustrated in FIG. 2) through the input unit 18 which is a selecting unit on the display unit 17. The electronic receipt displaying unit 83 displays various processes in relation to a portion or all of the electronic receipt information as process categories selectable in a menu. In addition, the electronic receipt displaying unit 83 displays a process for extracting the electronic receipt information to which the additional information is added according to the kind of the additional information as a process category selectable in the menu.

First, as illustrated in FIGS. 13A to 13C, the CPU 11 (in particular, the member correlating unit 81) of the portable terminal 8 executes an authentication process according to an input of a membership code and a password by accessing the electronic receipt managing server 9 (Step S31). According to this, the portable terminal 8 and a predetermined consumer membership code are associated with each other.

After the authentication, the CPU 11 (in particular, the electronic receipt receiving unit 82) of the portable terminal 8 receives the additional information and the electronic receipt information managed in the electronic receipt managing area 53a according to the input membership code (Step S32). Further, the additional information and the electronic receipt information may be received by an email.

Next, the CPU 11 (in particular, the electronic receipt displaying unit 83) of the portable terminal 8 displays the top screen K illustrated in FIG. 2 on the display unit 17 (Step S33). The portable terminal 8 prompts the user who is the consumer to select a menu by displaying a plurality of menus for viewing the various items of information relating to the electronic receipt information on the display unit 17.

If it is determined that the user taps and selects the receipt display button B11 (Yes in Step S34), the CPU 11 (the electronic receipt displaying unit 83) of the portable terminal 8 displays the electronic receipt information corresponding to recent shopping activities of the user on the display unit 17 (Step S35).

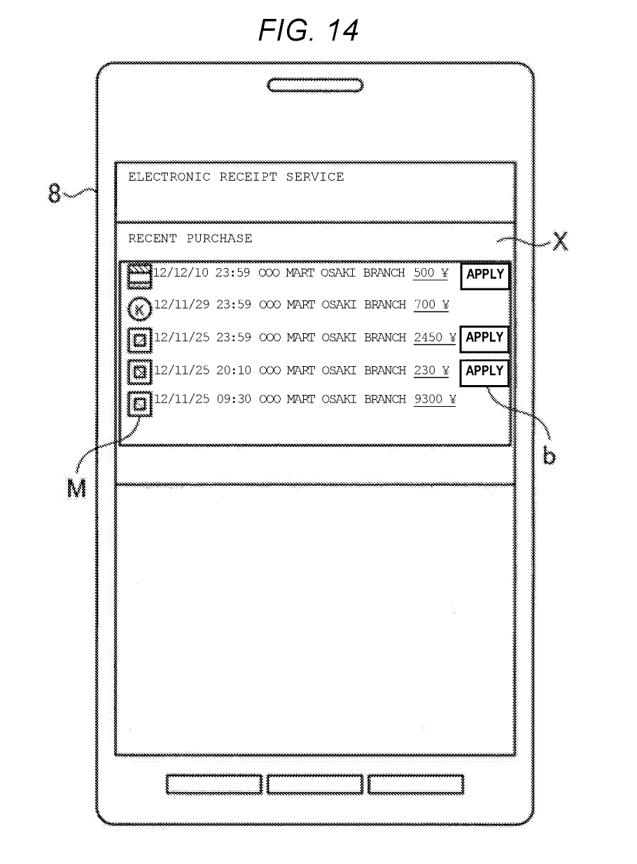

FIG. 14 is a front view illustrating a display example X in the display unit 17 of the portable terminal 8. As illustrated in FIG. 14, in the display example X, a list of the electronic receipt information corresponding to the recent shopping activities is displayed. As illustrated in FIG. 14, the electronic receipt information corresponding to the recent shopping activities includes dates of shopping, store names of companies, paid amounts of money, together with marks M of the stores of various companies at which the user having the portable terminal 8 accessing the electronic receipt managing server 9 shopped. Further, a table in which marks are associated in advance with company codes included in the electronic receipt information is prepared in order to display the marks M of the stores. Consequently, when a home page associated with a campaign is set, the electronic receipt information illustrated in FIG. 14 includes a button-shaped icon b on which the word “apply” is displayed. If the “apply” icon b described above is selected, the campaign page associated with the icon b is displayed on the display unit 17.

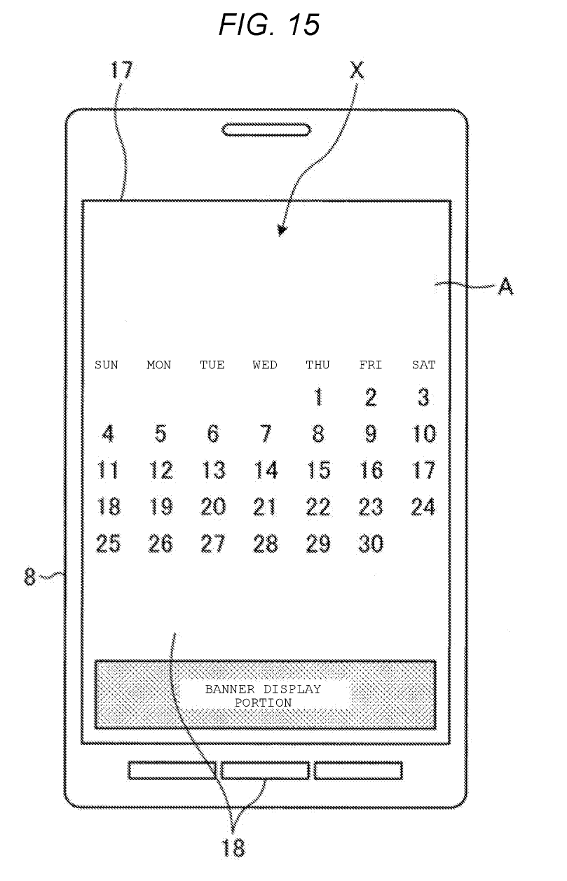

FIG. 15 is a front view illustrating a modification of a display example X in the display unit 17 of the portable terminal 8. As illustrated in FIG. 15, the modification of the display example X is an example in which the dates when the user having the portable terminal 8 accessing the electronic receipt managing server 9 shopped at the stores of various companies are displayed in a calendar-like list with colors changed. In addition, the CPU 11 (the electronic receipt displaying unit 83) of the portable terminal 8 performs display so that the desired date may be selected with a cursor that follows the input of the input unit 18 among the dates displayed in the list with colors changed. The portable terminal 8 prompts the user who is the consumer to select the information by displaying the list of the purchase dates on the display unit 17.

If it is determined that the user taps and selects a desired date (Yes in Step S36), the CPU 11 (the electronic receipt displaying unit 83) of the portable terminal 8 displays the electronic receipt information corresponding to the selected date on the display unit 17 (Step S37).

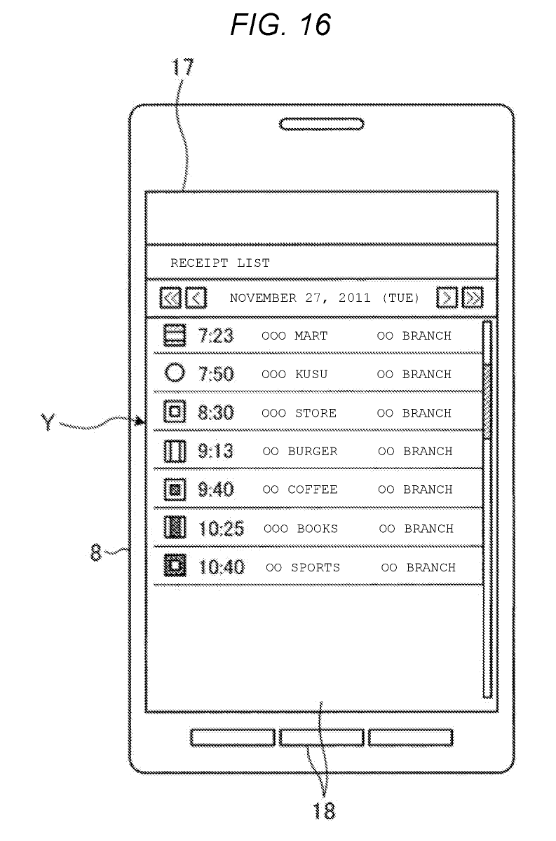

FIG. 16 is a front view illustrating a display example Y in the portable terminal. As illustrated in FIG. 16, the display example Y displays stores of various companies at which the user having the portable terminal 8 accessing the electronic receipt managing server 9 shopped, on a daily basis. More specifically, the display example Y is sequentially displayed in a time order in which the electronic receipt information is received, and company marks, transaction times, company names, store names are displayed. In addition, the CPU 11 (the electronic receipt displaying unit 83) of the portable terminal 8 performs display so that the desired stores displayed on a daily basis may be selected with a cursor that follows the input of the input unit 18 among the store information displayed on a daily basis in a list.

If it is determined that the user selects the desired store displayed on a daily basis (Yes in Step S38), the CPU 11 (the electronic receipt displaying unit 83) of the portable terminal 8 displays the electronic receipt information corresponding to the selected store displayed on a daily basis on the display unit 17 (Step S39).

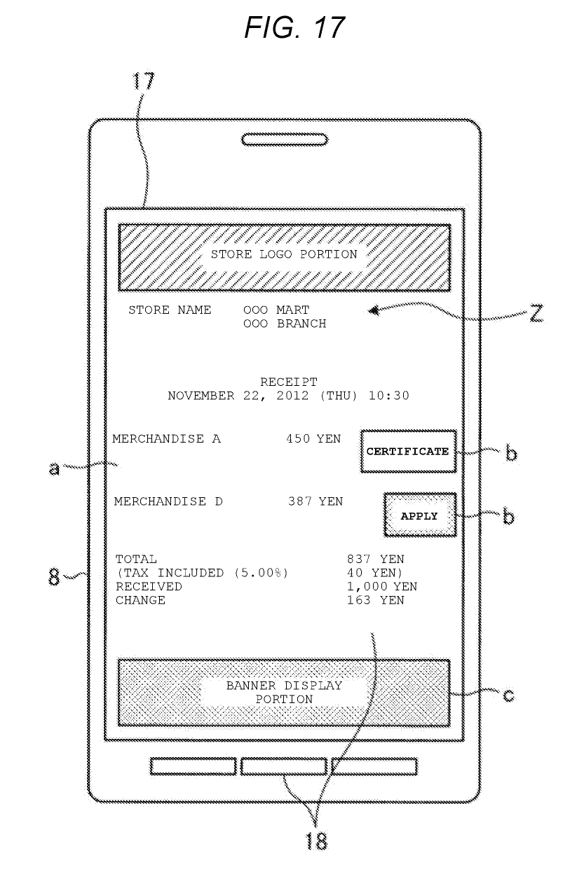

FIG. 17 is a front view illustrating a display example Z in the display unit 17 of the portable terminal 8. As illustrated in FIG. 17, in the display example Z, the electronic receipt information of the desired store on a desired date when the user having the portable terminal 8 accessing the electronic receipt managing server 9 shopped is displayed. In the display example Z, while a layout is made to be the same as the paper receipt by analyzing the electronic receipt information, merchandise a or the icons b (button-shaped icons indicating “apply” or “certificate” in FIG. 17) indicating various items of additional information associated with the merchandise may be focused by the cursor that follows the input of the input unit 18 in the electronic receipt information.

Further, the screen display image may not be necessarily the receipt image. However, the electronic receipt information is a substitution of the paper receipt information, and is electronic merchandise proof of purchase information that proves the purchase of the merchandise. In the display example Z, the following information is displayed to be used for the presentation as the merchandise proof of purchase information to the store when returning merchandise.
Store name
Date of purchase
Details of purchased merchandise
Total amount of sales
Received amount of money
Change amount
Cashier number
Transaction number

Here, if the user selects appropriate merchandise, or an appropriate icon corresponding to the merchandise (Yes in Step S40), the CPU 11 (the electronic receipt displaying unit 83) of the portable terminal 8 is connected to the network 5 through the network interface 14, obtains various items of information based on the access information associated with the selected merchandise or icon from the network 5, and displays the information on the display unit 17 (Step S41).

For example, when the home page associated with the merchandise as access information to the merchandise a is set to be a merchandise information link, if desired merchandise is selected, the home page associated with the corresponding merchandise is displayed on the display unit 17.

In addition, among the merchandises displayed in the purchase merchandise detail, the button-shaped icon b on which the character of “apply” is displayed corresponds to the merchandise name of the merchandise in which the home page associated with the campaign is set to be displayed. If the “apply” icon b described above is selected, the campaign page associated with the corresponding icon b is displayed on the display unit 17.

In addition, among the merchandise displayed in the purchase merchandise detail, the button-shaped icon b on which the character of “certificate” is displayed corresponds to the merchandise name of the merchandise on which the certificate may be displayed to be displayed. If the “certificate” icon b described above is selected, the certificate check request is transmitted to the electronic receipt managing server 9 for the merchandise associated with the corresponding icon b.

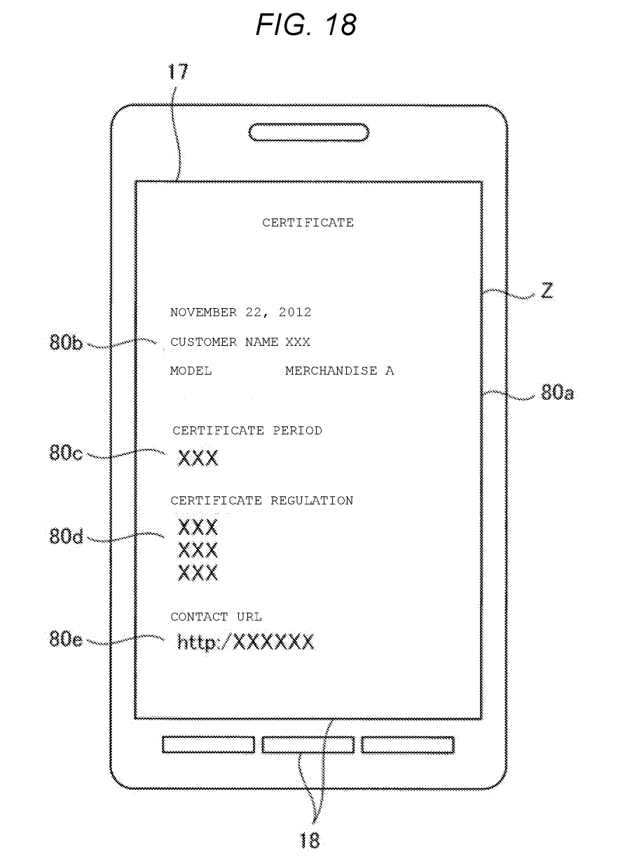

FIG. 18 is a diagram illustrating an example of certificate information 80a which is received from the electronic receipt managing server 9 when the “certificate” icon b is operated and displayed on the display unit 17. As the certificate information 80a, in addition to the display indicating that the displayed information is the certificate, customer information and the merchandise information 80b of the purchased merchandise, a certificate period 80c, a certificate regulation 80d regulating the certified condition and the contract, contact information (mail address and the like) 80e of a manufacturer who issues the certificate, and the like are displayed. The contact 80e is operably displayed and may access the home page of the manufacturer by operating the contact 80e. In addition, the displayed certificate information 80a may be downloaded and managed on the portable terminal 8.

In addition, when a home page associated with a commercial as access information to a banner c is set, if the banner c is selected, the commercial associated with the corresponding banner c is displayed on the display unit 17.

If the end of the electronic receipt viewing process is announced from the input unit 18 (Yes in Step S42), the process returns to Step S33, and the CPU 11 of the portable terminal 8 displays the top screen K illustrated in FIG. 2 on the display unit 17.

If the end of the electronic receipt viewing process is not announced from the input unit 18 (No in Step S42), the process returns to Step S40, and the CPU 11 of the portable terminal 8 waits for the selection of the merchandise or the icon associated with the merchandise.

Meanwhile, if it is determined that the user taps and selects the household account book button B12 (Yes in Step S43), the CPU 11 (the electronic receipt displaying unit 83) of the portable terminal 8 extracts the information required to generate the statistics information such as the period for generating the predetermined statistics information (summary) and the classification of the statistics information, from the electronic receipt information (Step S44). Further, for keys to generate the statistics information (summary), for example, the following settings are possible.
Date of purchase
Store for purchase
Location and region of purchase
Seller business type
Purchase merchandise
Purchase merchandise genre (category)
Purchase amount of money
The number of items of purchase
Payment media (Cash, credit card, and the like)

Next, the CPU 11 (the electronic receipt displaying unit 83) of the portable terminal 8 generates the compiled statistics information based on the information (for example, the company code or the business type and business category code) required for the generation of the statistics information from the obtained electronic receipt information (Step S45), and displays the generated statistics information on the display unit 17 (Step S46).

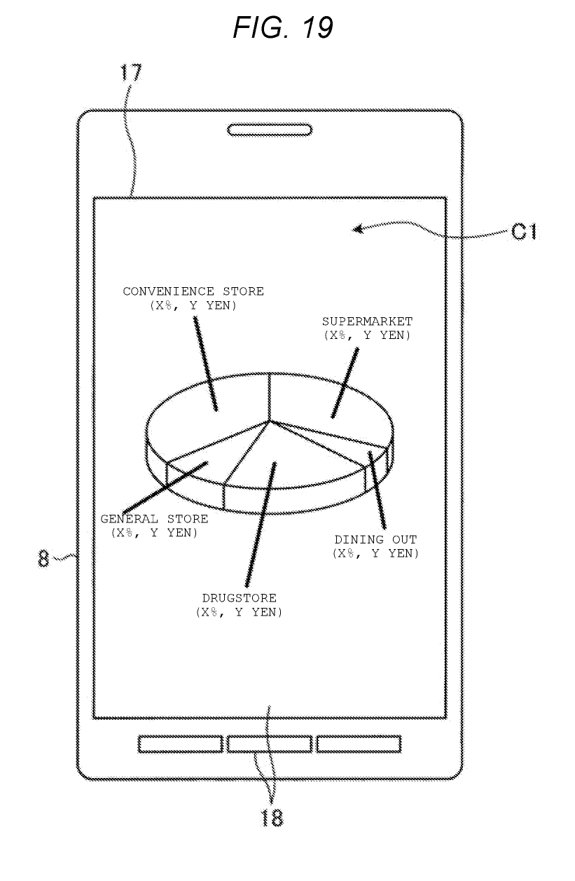

FIG. 19 is a front view illustrating a display example C1 in the display unit 17 of the portable terminal 8. As illustrated in FIG. 19, in the display example C1, a statistical result based on business type or business category for the total amount of sales in the merchandise sales data included in the electronic receipt information for the predetermined period is displayed with a pie chart. According to the display example C1, expenditure based on business type or business category and information on the store of which business type or business category, the purchase is frequently performed may be easily known.

Further, though the pie chart illustrated in FIG. 19 is obtained from the statistics on the basis of the business type and business category code included in the electronic receipt information, the business type and business category code may be arbitrarily set by the member so as to be used as a classification code for arbitrarily classifying companies.

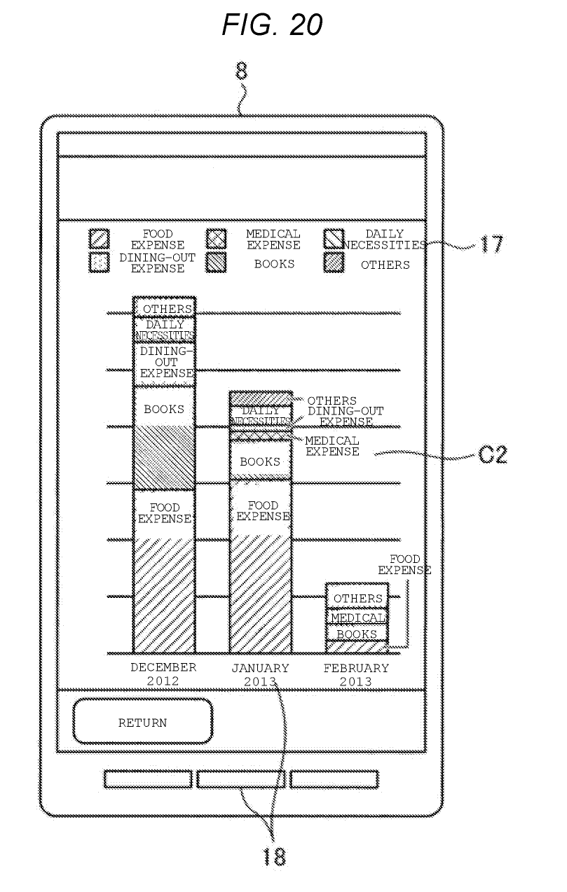

FIG. 20 is a front view illustrating a different display example C2 in the display unit 17 of the portable terminal 8. As illustrated in FIG. 20, in the display example C2, the category-based statistical result of the total amount of sales among the merchandise sales data included in the electronic receipt information on a monthly basis is displayed with a bar graph. According to the display example C2, the expenditure or the ratio on the category basis may be easily known.

Meanwhile, if it is determined that the user taps and selects the campaign button B13 (Yes in Step S47), the CPU 11 (the electronic receipt displaying unit 83) of the portable terminal 8 extracts the electronic receipt information in relation to the merchandise that enables applying for the campaign (reward) (Step S48).

Next, the CPU 11 (in particular, the electronic receipt displaying unit 83) of the portable terminal 8 generates a list of the campaign information from the extracted electronic receipt information (or a list of the electronic receipt information to which the campaign information is added) (Step S49), and displays the generated list of the campaign information (or the list of the electronic receipt information to which the campaign information is added) on the display unit 17 (Step S50).

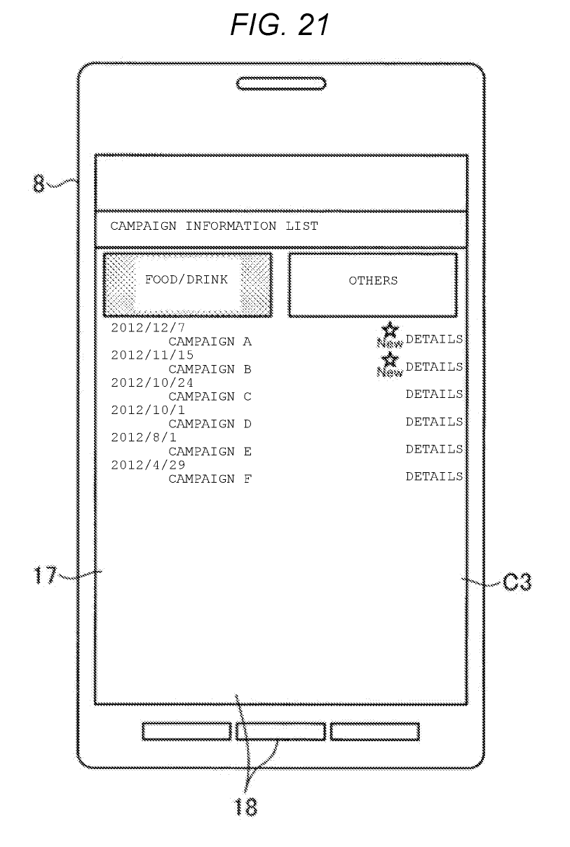

FIG. 21 is a front view illustrating a display example C3 in the display unit 17 of the portable terminal 8. As illustrated in FIG. 21, in the display example C3, a list of information for the merchandise that allows applying (proof of purchase) for the campaign (reward) (or electronic receipt information including information on merchandise that allows applying (proof of purchase) for campaign (reward)) is displayed.

Meanwhile, if it is determined that the user taps and selects the certificate button B14 (Yes in Step S51), the CPU 11 (the electronic receipt displaying unit 83) of the portable terminal 8 displays the certificate information 80a stored in the portable terminal 8 (or the electronic receipt information to which the certificate information 80a is added) on the display unit 17 (Step S52).

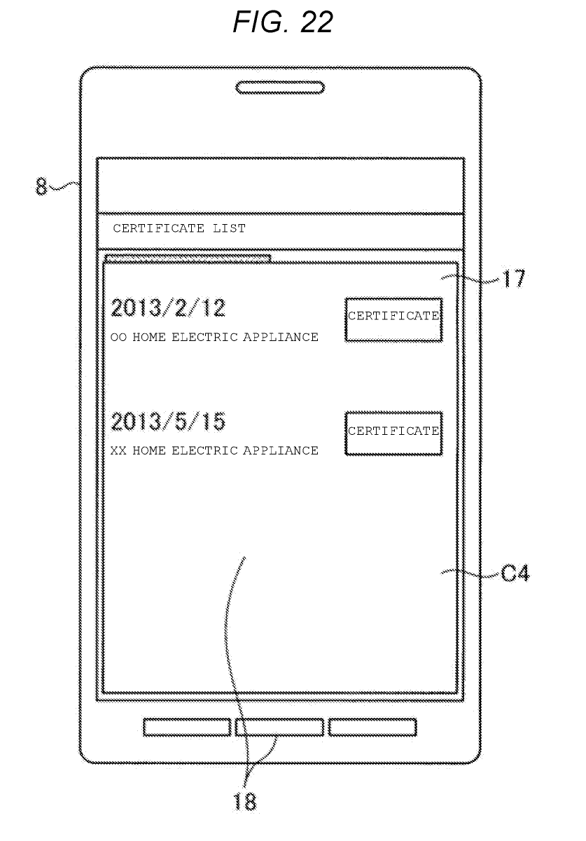

FIG. 22 is a front view illustrating a display example C4 in the display unit 17 of the portable terminal 8. As illustrated in FIG. 22, in the display example C4, the certificate information 80a (or the electronic receipt information to which the certificate information 80a is added) is displayed.

Meanwhile, if it is determined that the user taps and selects the coupon issuing button B15 (Yes in Step S53), the CPU 11 (in particular, the electronic receipt displaying unit 83) of the portable terminal 8 displays the coupon information stored in the portable terminal 8 (or electronic receipt information to which the coupon information is added) on the display unit 17 (Step S54).

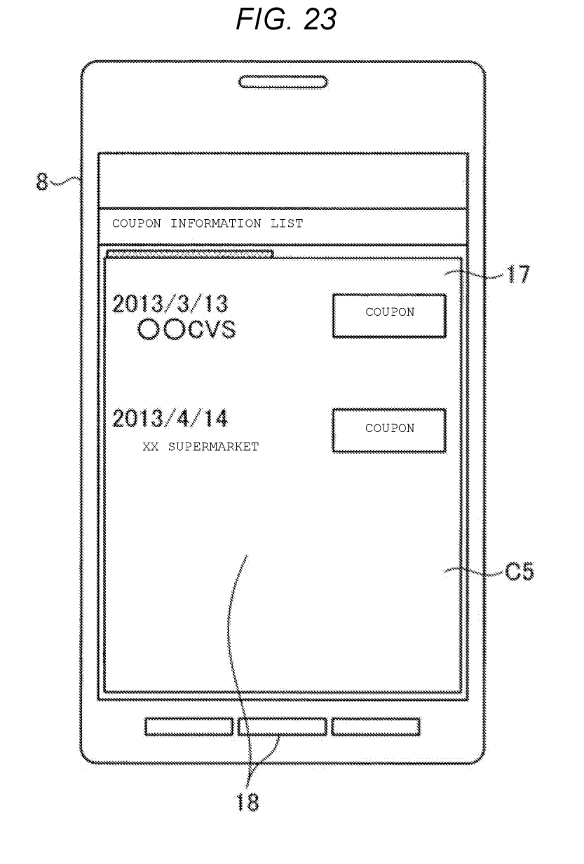

FIG. 23 is a front view illustrating a display example C5 in the display unit 17 of the portable terminal 8. As illustrated in FIG. 23, in the display example C5, the coupon information (or the electronic receipt information to which the coupon information is added) is displayed. According to this, the electronic receipt information may be used as a substitute of individual sales promotion receipt or other business type coupon (capable of receiving a gasoline discount coupon of GS when shopping in CVS, and the like) used with a paper medium in the related art.

Further, after various information are displayed (Step S46, S50, S52, S54, and S56), if the end of the display of various information is announced from the input unit 18 (Yes in Step S57), the process returns to Step S33, and the CPU 11 of the portable terminal 8 displays the top screen K illustrated in FIG. 2 on the display unit 17.

In this manner, according to the electronic receipt system in the exemplary embodiment, since the system of the electronic receipt may be introduced beyond the scope of one company differently from the electronic receipt system of the related art, the introduction of the electronic receipt may be promoted.

In this manner, according to the electronic receipt system of the embodiment, the plurality of process categories corresponding to the electronic receipt information are displayed on the display unit 17 as the menu (the top screen K illustrated in FIG. 2) selectable through the input unit 18 which is the selecting unit so that the operation of the consumer for confirming the plurality of process categories (receipt viewing and searching, shopping result summary displaying, a merchandise proof of purchase, a certificate, a store issued coupon, a receipt share, and the like) corresponding to the electronic receipt information may be performed efficiently and intuitively.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

For example, if merchandise in which a certificate exists is purchased, the certificate information may be transmitted to the portable terminal 8 together with the electronic receipt information without transmitting the information indicating the existence of the certificate to the portable terminal 8. In this case, the portable terminal 8 displays the certificate information together with the received electronic receipt information at the same time.

In addition, the certificate information may be stored in the electronic receipt managing server 9, not in the electronic receipt server 6.

What is claimed is:

1. A system for distributing data, comprising:
a plurality of store servers corresponding to a plurality of stores, respectively, each of the store severs being configured to:
i) store an electronic receipt generated by a point of sale (POS) terminal of the corresponding store for a transaction made by a customer thereat, in association with warranty information,
ii) transmit the electronic receipt along with status information indicating that a warranty exists in relation to the electronic receipt, through a public network, and
iii) transmit the warranty information separately from the electronic receipt;
an electronic receipt management server connected to the store servers over a public network and configured to:
i) store the electronic receipt in association with the status information upon reception thereof from each of the store servers, and also transfer the electronic receipt along with the corresponding status information, and
ii) store the warranty information in association with the corresponding electronic receipt upon reception of the warranty information from each of the store servers, and transmit the warranty information in response to a request therefore; and
a client device wirelessly connectable to the public network and configured to:
i) control a touch panel display thereof to display a graphical user interface (GUI) including a plurality of first selectable objects each of which is to view an image of one of the electronic receipts that have been received from the electronic receipt management server along with the status information,
ii) control the touch panel display to display one of the received electronic receipts along with a second selectable object to view the warranty information corresponding thereto upon selection of one of the first selectable objects, and
iii) transmit the request for the warranty information corresponding to the displayed electronic receipt to the electronic receipt management server upon selection of the second selectable object.

2. The system according to claim 1, wherein
each of the store servers is further configured to determine whether or not warranty information associated with the electronic receipt exists, and upon determining that the warranty information exists, store the status information in association with the electronic receipt.

3. The system according to claim 1, wherein
each of the store servers transmits the warranty information in response to an inquiry from the electronic receipt management server.

4. The system according to claim 1, wherein
the client device is further configured to control the touch panel display to display a screen of the warranty information upon reception thereof from the electronic receipt management server.

5. The system according to claim 1, wherein
the displayed electronic receipt includes also a third selectable object for receipt splitting, and
the client device is further configured to generate a split electronic receipt corresponding to part of items included in said one of the displayed electronic receipt, in accordance with selection of the third selectable object, and transmit the split electronic receipt.

6. The system according to claim 5, wherein
the client device is further configured to update the displayed electronic receipt upon transmission of the split electronic receipt.

7. A method for distributing data using a system including a plurality of store servers corresponding to a plurality of stores, respectively, an electronic receipt management server, and a client device, the method comprising:
by each of the store servers,
i) storing an electronic receipt generated by a point of sale (POS) terminal of the corresponding store for a transaction made by a customer thereat, in association with warranty information;
ii) transmitting, to the electronic receipt management server, the electronic receipt along with status information indicating that a warranty exists in relation to the electronic receipt, through a public network; and
iii) transmitting, to the electronic receipt management server, the warranty information separately from the electronic receipt;
by the electronic receipt management server,
i) storing the electronic receipt in association with the status information upon reception thereof from each of the store servers, and also transferring the electronic receipt along with the corresponding status information to the client device; and
ii) storing the warranty information in association with the corresponding electronic receipt upon reception of the warranty information from each of the store servers, and transmitting, to the client device, the warranty information in response to a request therefore; and
by the client device,
i) controlling a touch panel display thereof to display a graphical user interface (GUI) including a plurality of first selectable objects each of which is to view an image of one of the electronic receipts that have been received from the electronic receipt management server along with the status information;
ii) controlling the touch panel display to display one of the received electronic receipts along with a second selectable object to view the warranty information corresponding thereto upon selection of one of the first selectable objects; and
iii) transmitting the request for the warranty information corresponding to the displayed electronic receipt to the electronic receipt management server upon selection of the second selectable object.

8. The method according to claim 7, further comprising:
by each of the store servers,
determining whether or not warranty information associated with the electronic receipt exists; and
storing the status information in association with the electronic receipt.

9. The method according to claim 7, further comprising:
by each of the store servers, transmitting the warranty information in response to an inquiry from the electronic receipt server.

10. The method according to claim 7, further comprising:
by the client device, controlling the touch panel display to display a screen of the warranty information upon reception thereof from the electronic receipt server.

11. The method according to claim 7, wherein
the displayed electronic receipt includes also a third selectable object for receipt splitting, and
the method further comprises: by the client device,
generating a split electronic receipt corresponding to part of items included in said one of the displayed electronic receipt, in accordance with selection of the third selectable object; and
transmitting the split electronic receipt.

12. The method according to claim 11, further comprising:
by the client device, updating the displayed electronic receipt upon transmission of the split electronic receipt.
